(19) United States
(12) Patent Application Publication
(10) Pub. No.: US 2025/0182246 A1
(43) Pub. Date: Jun. 5, 2025

(54) ASYMMETRIC MULTI-MODAL IMAGE FUSION

(71) Applicant: Microsoft Technology Licensing, LLC, Redmond, WA (US)

(72) Inventors: Michael BLEYER, Seattle, WA (US); Christian Markus MAEKELAE, Redmond, WA (US); Christopher Douglas EDMONDS, Carnation, WA (US)

(21) Appl. No.: 18/524,531

(22) Filed: Nov. 30, 2023

(51) Int. Cl. G06T 5/50; G06T 3/40; G06T 5/20; G06T 5/70

(52) U.S. Cl. CPC G06T 5/50; G06T 3/40; G06T 5/20; G06T 5/70; G06T 2207/20221

(57) ABSTRACT

A system for performing asymmetric multi-modal image fusion is configurable to (i) access a first image associated with a first imaging modality; (ii) decompose the first image into a first base layer and a first detail layer; (iii) determine a weight map based on pixel signals of the first image; and (iv) generate an output image by performing image fusion using the first base layer, the first detail layer, and a second detail layer associated with a second imaging modality that is different from the first imaging modality, where the weight map modifies the first detail layer and the second detail layer in the image fusion.

### BACKGROUND

Mixed-reality (MR) systems, including virtual-reality and augmented-reality systems, have received significant attention because of their ability to create truly unique experiences for their users. For reference, conventional virtual-reality (VR) systems create a completely immersive experience by restricting their users' views to only a virtual environment. This is often achieved, in VR systems, through the use of a head-mounted display (HMD) that completely blocks any view of the real world. As a result, a user is entirely immersed within the virtual environment. In contrast, conventional augmented-reality (AR) systems create an augmented-reality experience by visually presenting virtual objects that are placed in or that interact with the real world.

As used herein, VR and AR systems are described and referenced interchangeably. Unless stated otherwise, the descriptions herein apply equally to all types of mixed-reality systems, which (as detailed above) includes AR systems, VR reality systems, and/or any other similar system capable of displaying virtual objects.

Some mixed-reality systems are configured with cameras of different modalities to enhance users' views in various environments. For example, mixed-reality systems configured with long wavelength thermal imaging cameras facilitate visibility in smoke, haze, fog, and/or dust. Likewise, mixed-reality systems configured with low light imaging cameras facilitate visibility in dark environments where the ambient light level is below the level required for human vision.

In some instances, low light and thermal images may be fused or combined to provide users with visualizations from multiple camera modalities simultaneously. However, conventional techniques for fusing images of different modalities are associated with various challenges.

The subject matter claimed herein is not limited to embodiments that operate only in environments such as those described above. Rather, this background is only provided to illustrate one example technology area where some embodiments described herein may be practiced.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example system that may include or be used to implement disclosed embodiments.

FIG. 2A illustrates a conceptual representation of obtaining images of different modalities and decomposing the captured images into respective base layers and detail layers.

FIG. 2B illustrates a conceptual representation of determining a weight map based on pixel signals of a captured image of FIG. 2A.

FIG. 2C illustrates a conceptual representation of generating a fused image based on a base layer and detail layers of FIG. 2A, the weight map of FIG. 2B, and a pedestal.

FIGS. 3-5 illustrate example flow diagrams depicting acts associated with asymmetric multi-modal image fusion.

### DETAILED DESCRIPTION

Disclosed embodiments include systems, devices, techniques, and methods for facilitating asymmetric multi-modal image fusion.

### Examples of Technical Benefits, Improvements, and Practical Applications

Those skilled in the art will recognize, in view of the present disclosure, that at least some of the disclosed embodiments may address various shortcomings associated with conventional approaches, devices, and/or techniques for fusing images of different modalities. The following section outlines some example improvements and/or practical applications provided by the disclosed embodiments. It will be appreciated, however, that the following are examples only and that the embodiments described herein are in no way limited to the example improvements discussed herein.

As noted hereinabove, low light and thermal images may be fused or combined to provide users with visualizations from multiple camera modalities simultaneously. However, conventional techniques for fusing images of different modalities are associated with various challenges. For instance, a common branch of fusion algorithms is saliency-based. Saliency-based algorithms extract, for each image modality, a so-called saliency map that measures how interesting (e.g., salient) a pixel is. A typical way to measure saliency is via computing the magnitude of the image gradient. A fused image is then obtained by merging the most interesting (e.g., most salient) parts of both input images (e.g., two images of different image modalities). Other fusion algorithms apply image decomposition for each input. A common choice is wavelet decomposition. The wavelet coefficient images of both modalities are then fused. Finally, an output image is obtained via the inverse wavelet transform of fused coefficients.

The above and other conventional methods for fusing images of different modalities assign the same importance to both images. Such conventional approaches can therefore be regarded as symmetrical. However, in many implementations, there is a preferred image modality. For instance, when fusing a visible light image (e.g., low light image) with a thermal light image (e.g., thermal image), users often prefer visible light information over thermal light information, as users can often more easily interpret visible light information to identify objects of interest (e.g., people) and/or navigate within environments (e.g., walking in a forest or other hazardous environment). Thus, when the signal level of the visible light image is sufficiently high, fusing thermal information can be undesired. In such instances, fusing thermal information can cause users to become overwhelmed with “thermal clutter” and lose focus on more essential visible information. In some cases, thermal clutter can be the result of imperfect alignment (e.g., parallax correction) between the visible light and thermal images, which can manifest as the same object edge showing up twice at slightly different positions in the fused image (e.g., double edges). Such artifacts can be distracting and/or dangerous for users and can otherwise undermine user experiences.

Notwithstanding the foregoing, when the signal level of the visible light image is low, fusing thermal information can provide a fused/output image that captures scene information that the visible light image fails to detect. Image fusion in such instances can assist users in continuing to interpret their environment in very low visible light environments.

At least some disclosed embodiments are directed to an asymmetric approach to image fusion, in which a preferred image modality introduces asymmetric treatment of the input modalities. In one example, visible light information is used as a primary image source, and thermal information is used as a fallback or secondary image source when the visible light signal level becomes sufficiently low. Disclosed asymmetric fusion techniques can progressively enrich, replace, or supplement the visible light image data with thermal information when the visible light camera signal becomes low.

For instance, disclosed asymmetric fusion techniques can include decomposing the visible light and thermal images into respective high-frequency and low-frequency components. The output or fused image can be constructed using (i) the low-frequency component of the visible light image (e.g., the preferred imaging modality) and (ii) high-frequency information obtained by combining the high-frequency components of the visible light and thermal images. The combination of the high-frequency components of the visible light and thermal images to obtain the high-frequency information for the output or fused image can be based on signal level measurements associated with the visible light image. For instance, low-signal regions in the visible light image can result in a higher contribution of the thermal high-frequency information for such regions, whereas high-signal regions in the visible light image can result in a lower contribution of the thermal high-frequency information for such regions.

The disclosed techniques can provide output or fused imagery that advantageously emulates the appearance of the preferred image modality (e.g., visible light), even if most or all of the fused image data (e.g., high-frequency information) comes from the thermal camera. Such functionality can improve user interpretability of the output or fused imagery. The disclosed techniques can prevent users from losing visual information and situational awareness in the absence of a strong visible light signal. In some instances, the transition from visible light to thermal light information in the output/fused image can be less noticeable (e.g., when visible light signal levels fall). The problem of double edges can be drastically reduced (e.g., double edges can only occur at specific light levels during the transition from visible to thermal spectrums in the fusion module).

Although various examples described herein are focused, in at least some respects, on implementations in which visible light imagery (e.g., low light imagery) is fused with thermal imagery and in which visible light is the preferred imaging modality, the principles disclosed herein can be applied in other contexts, such as where different types, combinations, and/or quantities of image modalities are fused and/or where a different preferred imaging modality is used.

### Example Systems and Components

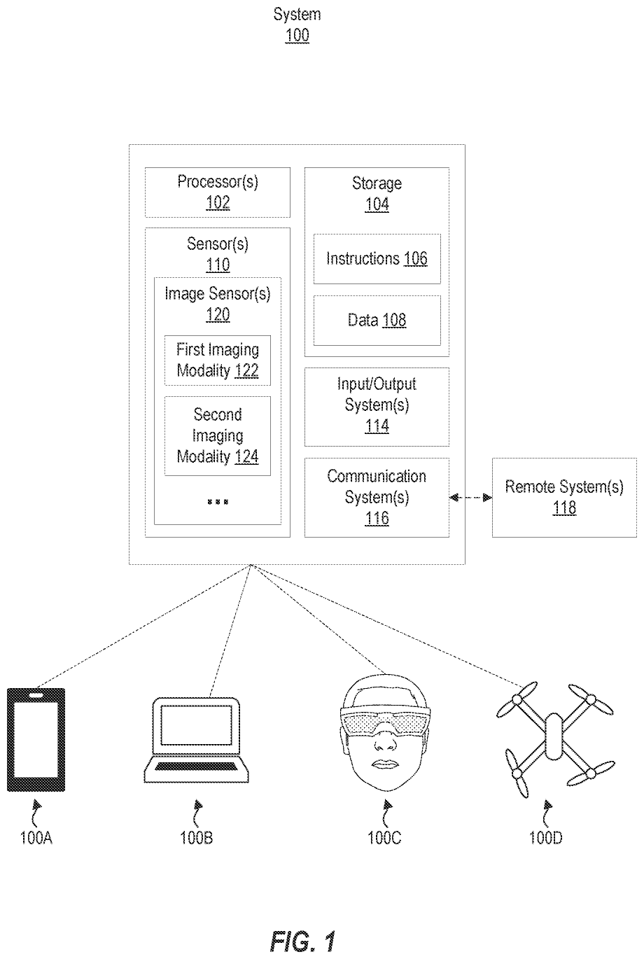

FIG. 1 illustrates various example components of a system 100 that may be used to implement one or more disclosed embodiments. For example, FIG. 1 illustrates that a system 100 may include processor(s) 102, storage 104, sensor(s) 110, input/output system(s) 114 (I/O system(s) 114), and communication system(s) 116. Although FIG. 1 illustrates a system 100 as including particular components, one will appreciate, in view of the present disclosure, that a system 100 may comprise any number of additional or alternative components.

The processor(s) 102 may comprise one or more sets of electronic circuitries that include any number of logic units, registers, and/or control units to facilitate the execution of computer-readable instructions (e.g., instructions that form a computer program). Such computer-readable instructions may be stored within storage 104. The storage 104 may comprise one or more computer-readable recording media and may be volatile, non-volatile, or some combination thereof. Furthermore, storage 104 may comprise local storage, remote storage (e.g., accessible via communication system(s) 116 or otherwise), or some combination thereof. Additional details related to processors (e.g., processor(s) 102) and computer storage media (e.g., storage 104) will be provided hereinafter.

In some implementations, the processor(s) 102 may comprise or be configurable to execute any combination of software and/or hardware components that are operable to facilitate processing using machine learning models or other artificial intelligence-based structures/architectures. For example, processor(s) 102 may comprise and/or utilize hardware components or computer-executable instructions operable to carry out function blocks and/or processing layers configured in the form of, by way of non-limiting example, single-layer neural networks, feed forward neural networks, radial basis function networks, deep feed-forward networks, recurrent neural networks, long-short term memory (LSTM) networks, gated recurrent units, autoencoder neural networks, variational autoencoders, denoising autoencoders, sparse autoencoders, Markov chains, Hopfield neural networks, Boltzmann machine networks, restricted Boltzmann machine networks, deep belief networks, deep convolutional networks (or convolutional neural networks), deconvolutional neural networks, deep convolutional inverse graphics networks, generative adversarial networks, liquid state machines, extreme learning machines, echo state networks, deep residual networks, Kohonen networks, support vector machines, neural Turing machines, and/or others.

As will be described in more detail, the processor(s) 102 may be configured to execute instructions 106 stored within storage 104 to perform certain actions. The actions may rely at least in part on data 108 stored on storage 104 in a volatile or non-volatile manner.

In some instances, the actions may rely at least in part on communication system(s) 116 for receiving data from remote system(s) 118, which may include, for example, separate systems or computing devices, sensors, and/or others. The communications system(s) 116 may comprise any combination of software or hardware components that are operable to facilitate communication between on-system components/devices and/or with off-system components/devices. For example, the communications system(s) 116 may comprise ports, buses, or other physical connection apparatuses for communicating with other devices/components. Additionally, or alternatively, the communications system(s) 116 may comprise systems/components operable to communicate wirelessly with external systems and/or devices through any suitable communication channel(s), such as, by way of non-limiting example, Bluetooth, ultra-wideband, WLAN, infrared communication, and/or others.

FIG. 1 illustrates that a system 100 may comprise or be in communication with sensor(s) 110. Sensor(s) 110 may comprise any device for capturing or measuring data representative of perceivable or detectable phenomenon. By way of non-limiting example, the sensor(s) 110 may comprise one or more microphones, thermometers, barometers, magnetometers, accelerometers, gyroscopes, and/or others. FIG. 1 furthermore illustrates the sensor(s) 110 as including image sensor(s) 120, which can be configured to capture electromagnetic signals (e.g., light signals) in an environment and produce output signals usable to construct images (e.g., digital representations of real-world scenes).

The image sensor(s) 120 of a system 100 can include image sensors associated with different imaging modalities, such as visible light imaging modalities, thermal imaging modalities, ultraviolet imaging modalities, and/or others. Visible light imaging modalities can include the low light imaging modalities, such as where cameras are configured with large pixels for image sensing in environments with little ambient light, such as starlight conditions (e.g., about 10 lux or below). Thermal imaging modalities can implement long wave infrared cameras for detecting heat radiation. FIG. 1 illustrates that, in some implementations, the image sensor(s) 120 include at least a first image sensor adapted to capture images of a first imaging modality 122 and a second image sensor adapted to capture images of a second imaging modality 124. In examples described herein, the first imaging modality 122 comprises a visible light imaging modality, and the second imaging modality 124 comprises a thermal imaging modality, where the visible light imaging modality is treated as the preferred modality. However, as noted above, other combinations of modalities are within the scope of the present disclosure (as well as other designations of a preferred modality).

Furthermore, FIG. 1 illustrates that a system 100 may comprise or be in communication with I/O system(s) 114. I/O system(s) 114 may include any type of input or output device such as, by way of non-limiting example, a touch screen, a mouse, a keyboard, a controller, and/or others, without limitation. For example, the I/O system(s) 114 may include a display system that may comprise any number of display panels, optics, laser scanning display assemblies, and/or other components.

FIG. 1 conceptually represents that the components of the system 100 may comprise or utilize various types of devices, such as mobile electronic device 100A (e.g., a smartphone), personal computing device 100B (e.g., a laptop), a mixed-reality head-mounted display 100C (HMD 100C), an aerial vehicle 100D (e.g., a drone), other devices (e.g., self-driving vehicles, servers), combinations thereof, etc. A system 100 may take on other forms in accordance with the present disclosure.

### Asymmetric Multi-Modal Image Fusion

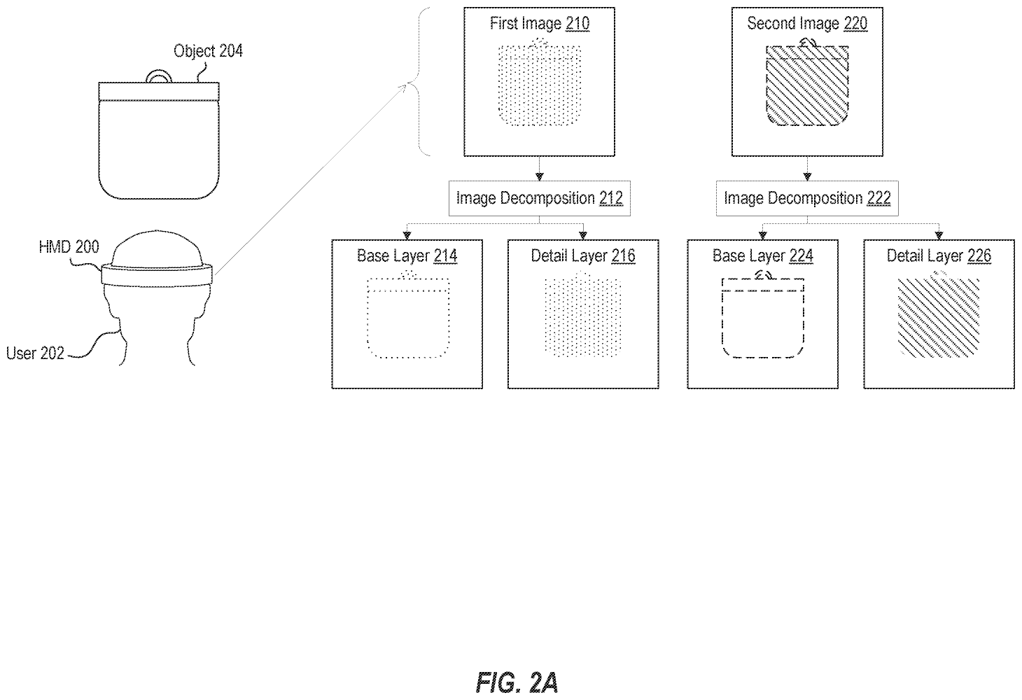

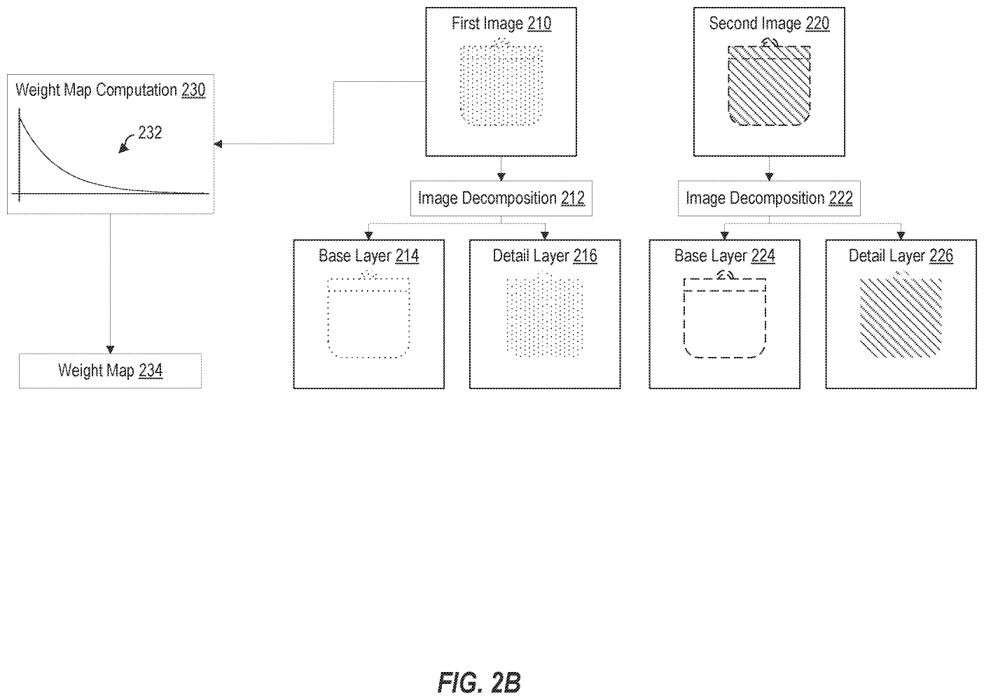

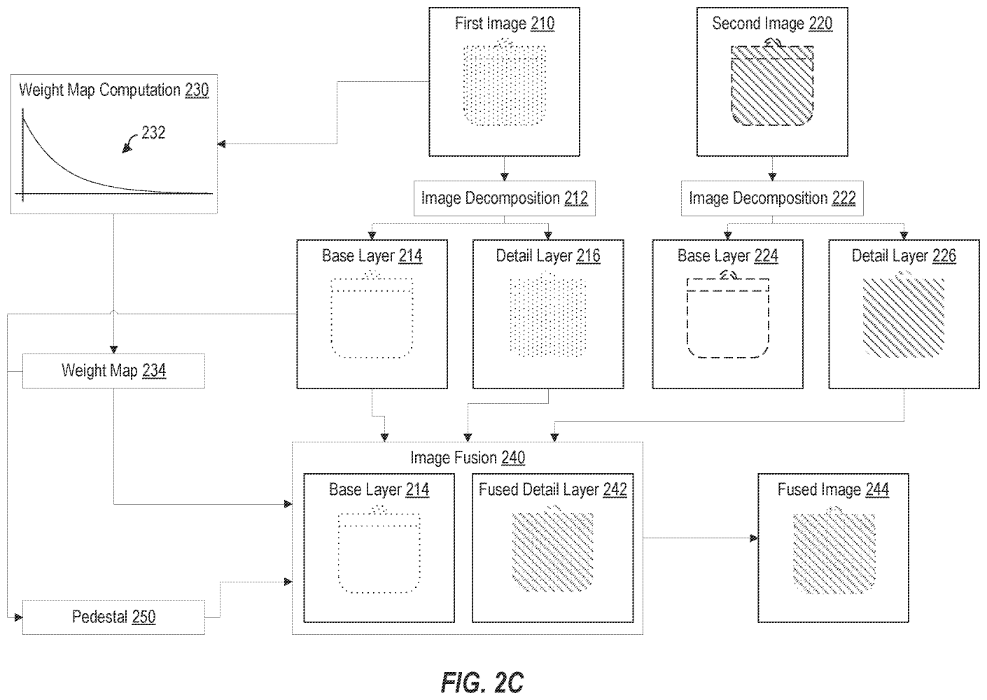

FIG. 2A illustrates a conceptual representation of obtaining images of different modalities. FIG. 2A illustrates an HMD 200 worn by a user 202 and directed toward an object 204 within an environment, such as a low light environment. The HMD 200 includes components of a system 100 described hereinabove. For instance, the HMD 200 includes image sensors 120, including a first image sensor associated with a first imaging modality 122 and a second image sensor associated with a second imaging modality 124. In the example of FIG. 2A, the first imaging modality 122 is a visible light imaging modality (e.g., for low light imaging), and the second imaging modality 124 is a thermal imaging modality (though other modalities can be used).

FIG. 2A illustrates a first image 210 captured by the first image sensor of the HMD 200 and a second image 220 captured by the second image sensor of the HMD 200. The first image 210 is thus associated with the first imaging modality 122, and the second image 220 is associated with the second imaging modality 124. In the example of FIG. 2A, the first image 210 and the second image 220 are geometry-corrected, meaning that the content of the first image 210 and the second image 220 is spatially aligned (e.g., through parallax correction, co-registration, reprojection, or other alignment/transformation techniques).

FIG. 2A conceptually depicts image decomposition 212 performed (e.g., via processor(s) 102) on the first image 210 to separate the first image 210 into constituent parts. As shown in FIG. 2A, image decomposition 212 involves decomposing the first image 210 into a base layer 214 (or “first base layer”) and a detail layer 216 (or “first detail layer”). In some implementations, the base layer 214 comprises a low-frequency component of the first image 210 capturing image information associated with low-magnitude changes or variations in pixel signals/values (e.g., representing broader features and/or overall trends in the first image 210). In FIG. 2A, the base layer 214 depicts features of broad surfaces of the object 204 according to the first imaging modality 122 (depicted with dotted lines).

In some implementations, the detail layer 216 comprises a high-frequency component of the first image 210 capturing image information associated with high-magnitude changes or variations in pixel signals/values (e.g., representing fine details, edges, and/or textures in the first image 210). In FIG. 2A, the detail layer depicts features of edges of the object 204 according to the first imaging modality 122 (depicted with dot patterns).

Image decomposition 212 may employ various techniques to obtain the base layer 214 and the detail layer 216. In one example, the base layer 214 is obtained by downscaling the first image 210 (e.g., via iterative pixel binning), filtering the downscaled image with a blurring or smoothing filter (e.g., a Gaussian filter), and upscaling the filtered image to the original resolution (e.g., the resolution of the first image 210). The detail layer 216 can be determined by subtracting the base layer 214 from the first image 210 (e.g., via pixel-wise subtraction). In such implementations, the first image 210 can be reconstructed by summing the base layer 214 and the detail layer 216. Other techniques may be utilized to obtain a base layer and a detail layer from the first image 210, such as Fourier transforms, wavelet transforms, and/or others.

FIG. 2A also depicts image decomposition 222 performed (e.g., via processor(s) 102) on the second image 220 to separate the second image 220 into a base layer 224 (or “second base layer”) and a detail layer 226 (or “second detail layer”). Similar to base layer 214 and detail layer 216, base layer 224 may comprise a low-frequency component of the second image 220, and detail layer 226 may comprise a high-frequency component of the second image 220. In FIG. 2A, base layer 224 depicts features of broad surfaces of the object 204 according to the second imaging modality 124 (depicted with dashed lines), and detail layer 226 depicts features of edges of the object 204 according to the second imaging modality 124 (depicted with line patterns).

Image decomposition 222 for obtaining base layer 224 and detail layer 226 can be operationally similar to image decomposition 212. For instance, image decomposition 222 can involve downsampling the second image 220, filtering the downsampled image, and upsampling the filtered image to obtain the base layer 224, and can involve subtracting the base layer 224 from the second image 220 to obtain the detail layer 226. Additional or alternative techniques may be employed by image decomposition 222 to obtain a base layer and a detail layer from the second image 220.

In some instances, subtracting a base layer from an image can result in negative pixel values in a resulting detail layer. As will be described in more detail hereinafter, the negative values can be addressed by implementing a pedestal to obtain the image fusion output.

In the example of FIG. 2A, the first image 210 associated with the first imaging modality 122 (visible light) is treated as a preferred imaging modality (e.g., based on the intended use case of presenting the image fusion output to users to enable users to interpret their environment). A system can thus determine per-pixel signal quality measurements based on the first image 210. The per-pixel signal quality measurements can be used to determine the contribution of the non-preferred imaging modality (i.e., the second imaging modality 124 (thermal)) to the image fusion output (on a per-pixel basis). In this way, pixels for which the visible light signal quality is high can be defined primarily (or solely) using visible light image information, whereas pixels for which the visible light signal quality is low can be at least partially defined using thermal image information.

FIG. 2B illustrates a conceptual representation of determining a weight map 234 by performing weight map computation 230 (e.g., via processor(s) 102) based on the first image 210 (or data used to obtain the first image). In some implementations, the weight map 234 comprises an alpha map that assigns a respective weight to each pixel for the image fusion output, where the respective weights can take on values between 0 and 1. A weight value of 0 can indicate that the image fusion will rely on visible light image data (e.g., the preferred imaging modality) for the particular pixel, whereas a weight value of 1 can indicate that the image fusion will rely on thermal image data (e.g., the non-preferred imaging modality) for the particular pixel.

The weight map computation 230 can involve assessing pixel signals associated with the first image 210 (or data used to obtain/construct the first image 210) and assigning per-pixel weights for the weight map 234 based on the pixel signals. In one example, such as where the image sensor that captures the first image 210 is a single-photon avalanche diode (SPAD) image sensor, the pixel signals are based on per-pixel photon counts (e.g., in a photon count image), which are proportional to signal level (or light level) for each pixel. The photon count image that provides the pixel signals for weight map computation 230 can comprise a full-resolution photon count image (associated with the first image 210) or can be a transformation of the full-resolution photon count image (e.g., a downsampled, filtered, and upsampled photon count image, or a photon count image subject to joint bilateral filtering or other edge-preserving filtering).

Other types of data in addition or as an alternative to photon count data can be used as pixel signals to determine per-pixel weights for the weight map 234, such as pixel values of the first image 210 or per-pixel photo-induced electrical charge levels (e.g., for complementary metal-oxide-semiconductor (CMOS) or charge-coupled device (CCD) image sensors).

In the example of FIG. 2B, the weight map computation 230 involves evaluating a weighting function 232 at each of the pixel signals associated with the first image 210. The weighting function 232 of FIG. 2B can convert photon counts (or other pixel signals) into weight values (or alpha values) for the weight map 234 (or alpha map). For low photon counts, the weighting function 232 assigns a higher weight value, which results in a greater reliance on thermal image data in the image fusion. For high photon counts, the weighting function 232 assigns a lower weight value, which results in a lesser reliance on thermal image data in the image fusion. An example weighting function 232 can take the form of a negative exponential function, such as:

$$α ( photon\_count ) = exp ( - a * photon\_count ) \qquad ( 1 )$$

where “a” is the assigned weight value for the weight map 234 and “a” is a tuning parameter, which can be set to different values depending on how many photons per pixel are needed to produce a meaningful signal. The weighting function 232 described above differs substantially from traditional fusion algorithms, which typically compare the strength of certain image features in both images and assign higher weight to the modality that gives a stronger feature response. In contrast, the weighting function 232 described above relies on the signal level of the primary image modality to compute weight values (which can also be more computational efficient than comparing the strength of feature responses across different images).

Other types of weighting functions 232 can be utilized in accordance with the disclosed principles (e.g., other weighting functions that define a negative relationship between (i) per-pixel signal quality measurements of the preferred imaging modality and (ii) per-pixel contributions of image data of the non-preferred imaging modality).

The weight map 234 can be used in conjunction with base layer 214 (visible light, or preferred modality), detail layer 216 (visible light, or preferred modality), and detail layer 226 (thermal, or non-preferred modality) to obtain a fused image. FIG. 2C illustrates a conceptual representation of performing image fusion 240 (e.g., via processor(s) 102) to generate a fused image 244. As shown in FIG. 2C, image fusion 240 utilizes base layer 214 (low light), detail layer 216 (low light), detail layer 226 (thermal), the weight map 234, and pedestal 250 as inputs to determine generate the fused image 244 (or “output image”).

Notably, in the example of FIG. 2C, image fusion 240 refrains from utilizing base layer 224 (thermal), instead relying on base layer 214 of the first imaging modality 122 for the low-frequency content of the scene. This is indicated in FIG. 2C by base layer 214 being directly represented within image fusion 240. Such functionality can enable the fused image 244 to maintain the general appearance of having been captured in accordance with the first imaging modality 122, even where the second imaging modality 124 is relied upon for at least some high-frequency scene content via detail layer 226.

In the example of FIG. 2C, the weight map 234 modifies or controls the contribution of detail layer 216 (low light) and detail layer 226 (thermal) in image fusion 240. For instance, FIG. 2C illustrates a fused detail layer 242 in association with image fusion 240, which can be constructed by fusing detail layer 216 (low light) with detail layer 226 (thermal) in accordance with the weight map 234. The per-pixel weight values of the weight map 234 can define per-pixel contributions of detail layer 216 (low light) and detail layer 226 (thermal) to the fused detail layer 242. In one example, each pixel in the fused image 244 is constructed as follows (with values being obtained from corresponding pixel coordinates in the various components that contribute to the fused image 244):

$$fused image = visible light base layer + ( 1 - α ) * visible light detail layer + α * thermal detail layer + pedestal \qquad ( 2 )$$

where α is defined according to Equation (1) discussed above and where the combination of terms (1−α)*visible light detail layer+α+thermal detail layer defines the fused detail layer 242. In FIG. 2C, the fused detail layer 242 depicts features of the edges of the object 204 according to a combination of the first imaging modality 122 and the second imaging modality 124 (depicted with line and dot patterns). Although FIG. 2C depicts the fused detail layer 242 as including aspects of both the first imaging modality 122 and the second imaging modality 124, the fused detail layer 242 can include aspects of only one of the two modalities (e.g., based on the value of a).

As shown in Equation (2) and FIG. 2C, the fused detail layer 242 can be combined with base layer 214 (defined by the term visible light base layer) pursuant to obtaining the fused image 244. FIG. 2C depicts the fused image 244 as including low-frequency content from base layer 214 (visible light, depicted with dotted lines) and high-frequency content from the fused detail layer 242 (a combination of visible light and thermal, depicted with line and dot patterns).

Equation (2) also includes a pedestal component, which corresponds to pedestal 250 shown in FIG. 2C as contributing to the image fusion 240 for generating the fused image 244. As noted above, asymmetric fusion techniques that involve defining detail layers by subtracting a corresponding base layer from a corresponding initial image (e.g., first image 210 or second image 220) can result in the negative values in the detail layers. In many cases, including base layer 214 in the image fusion 240 as shown in FIG. 2C (and Equation (2)) can shift the resulting pixel value in the fused image 244 into the positive domain. However, under very low light levels, base layer 214 will have very low pixel values, which can limit the ability of base layer 214 to shift resulting pixel values in the fused image 244 into the positive domain.

One solution is to clamp negative values in the fused image to 0. However, such an approach can eliminate valuable scene information contained in the detail layers (e.g., detail layer 226). Alternatively, pedestal 250 (and the pedestal component of Equation (2)) can be added to image fusion 240 to shift pixel values of the fused image 244 into the positive domain. In one example, the pedestal (for each pixel value of the fused image 244) is defined as:

$$pedestal = max ( maxPedestal - visible light base layer , 0 ) * α \qquad ( 3 )$$

where maxPedestal represents the maximum pixel value of the pedestal image. In the example of Equation (3), the pedestal is based on a difference between the maxPedestal value and pixel values of the visible light base layer. Subtracting the visible light base layer from the maxPedestal can ensure that a pedestal is only added f there is not already enough positive offset in base layer 214 (or the visible light base layer term in Equation (2)).

The pedestal component of Equation (3) is also modified by a (e.g., weight values of the weight map 234). Multiplying by a as shown in Equation (3) can ensure that a high pedestal is only generated in the case of heavy reliance on the non-preferred imaging modality (e.g., where a is close to 1).

The fused image 244 can advantageously emulate the appearance of the preferred image modality (e.g., visible light), even where the image data of the fused image 244 is influenced by detail layer 226 of the non-preferred imaging modality (e.g., thermal). The fused image 244 (or a derivative or transformed version thereof) can be displayed to the user 202 (e.g., via a display of the HMD 200) and can help prevent the user 202 from losing visual information and/or situational awareness in the absence of a strong visible light signal.

### Example Method(s)

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

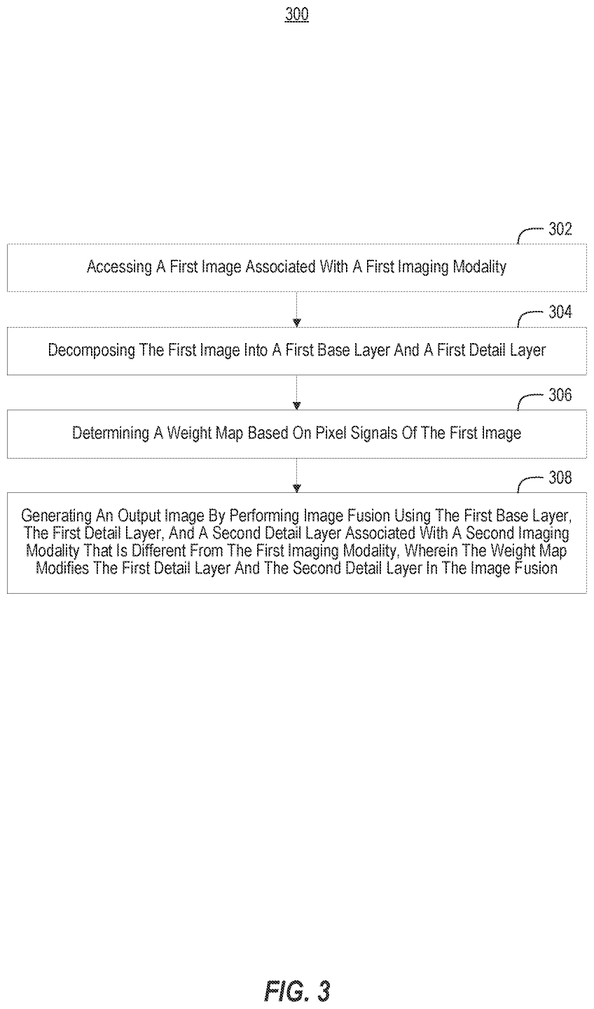

FIGS. 3-5 illustrate example flow diagrams 300, 400, and 500, respectively, depicting acts associated with asymmetric multi-modal image fusion. The various acts described with reference to FIGS. 3-5 can be performed by one or more components of a system 100, as described hereinabove.

Act 302 of flow diagram 300 of FIG. 3 includes accessing a first image associated with a first imaging modality. In some instances, the first imaging modality comprises a visible light imaging modality.

Act 304 of flow diagram 300 includes decomposing the first image into a first base layer and a first detail layer. In some implementations, the first base layer comprises a first low-frequency component of the first image, and the first detail layer comprises a first high-frequency component of the first image. In some examples, the first low-frequency component is determined by: (i) generating a downscaled first image by downscaling the first image; (ii) generating a filtered downscaled first image by applying a blurring or smoothing filter to the downscaled first image; and (iii) generating the first low-frequency component by upscaling the filtered downscaled first image. In some instances, the first high-frequency component is determined by subtracting the first low-frequency component from the first image.

Act 306 of flow diagram 300 includes determining a weight map based on pixel signals of the first image. In some implementations, the weight map comprises an alpha map. In some examples, values of the alpha map are determined by evaluating a negative exponential function at each of the pixel signals of the first image.

Act 308 of flow diagram 300 includes generating an output image by performing image fusion using the first base layer, the first detail layer, and a second detail layer associated with a second imaging modality that is different from the first imaging modality, wherein the weight map modifies the first detail layer and the second detail layer in the image fusion. In some instances, the second imaging modality comprises a thermal imaging modality. In some implementations, the second detail layer comprises a second high-frequency component of a second image associated with the second imaging modality. In some examples, the first image and the second image comprise geometry-corrected images. In some instances, the second detail layer is obtained by: (i) generating a downscaled second image by downscaling the second image; (ii) generating a filtered downscaled second image by applying a blurring or smoothing filter to the downscaled second image; (iii) generating a second low-frequency component by upscaling the filtered downscaled second image; and (iv) subtracting the second low-frequency component from the second image. In some examples, the image fusion refrains from using the second low-frequency component. In some instances, the image fusion further uses a pedestal component to shift pixel values into a positive domain. In some implementations, the pedestal component is based on differences between a maximum pedestal value and pixel values of the first base layer. In some examples, the pedestal component is modified by the weight map.

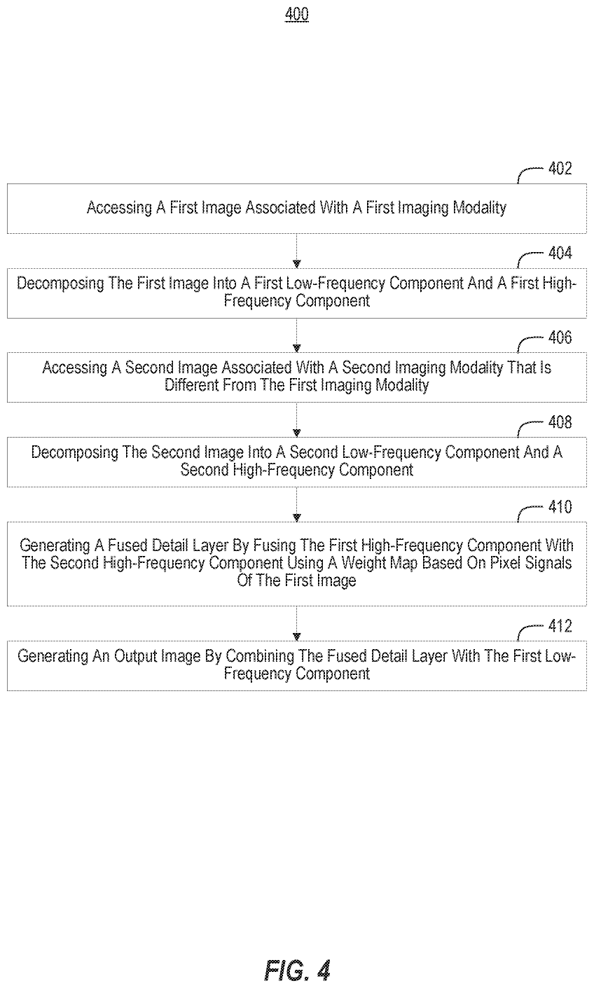

Act 402 of flow diagram 400 of FIG. 4 includes accessing a first image associated with a first imaging modality.

Act 404 of flow diagram 400 includes decomposing the first image into a first low-frequency component and a first high-frequency component.

Act 406 of flow diagram 400 includes accessing a second image associated with a second imaging modality that is different from the first imaging modality.

Act 408 of flow diagram 400 includes decomposing the second image into a second low-frequency component and a second high-frequency component.

Act 410 of flow diagram 400 includes generating a fused detail layer by fusing the first high-frequency component with the second high-frequency component using a weight map based on pixel signals of the first image. In some instances, values of the weight map are determined by evaluating a negative exponential function at each of the pixel signals of the first image.

Act 412 of flow diagram 400 includes generating an output image by combining the fused detail layer with the first low-frequency component. In some implementations, generating the output image refrains from using the second low-frequency component. In some examples, the output image is generated by applying a pedestal component to shift pixel values into a positive domain.

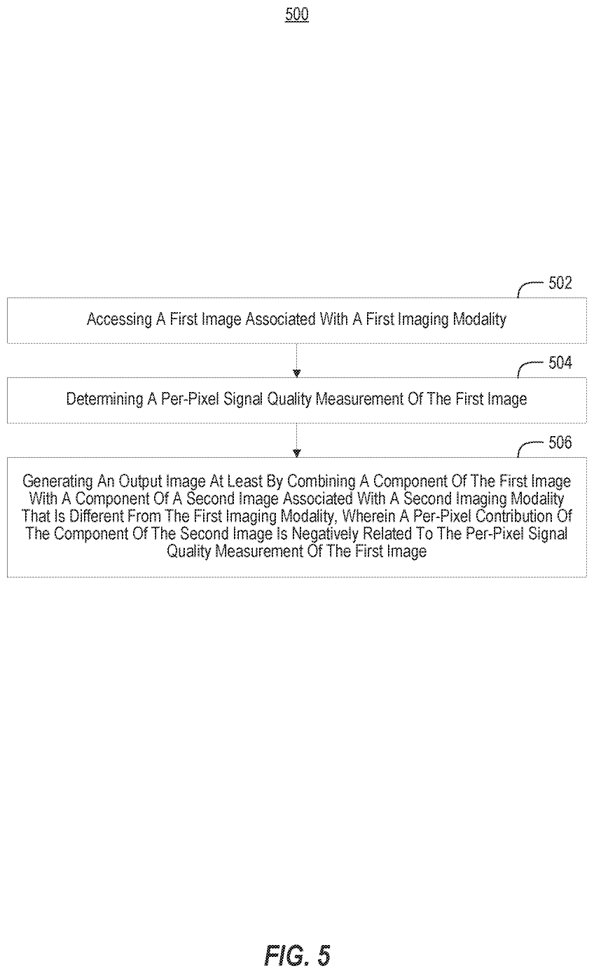

Act 502 of flow diagram 500 of FIG. 5 includes accessing a first image associated with a first imaging modality.

Act 504 of flow diagram 500 includes determining a per-pixel signal quality measurement of the first image.

Act 506 of flow diagram 500 includes generating an output image at least by combining a component of the first image with a component of a second image associated with a second imaging modality that is different from the first imaging modality, wherein a per-pixel contribution of the component of the second image is negatively related to the per-pixel signal quality measurement of the first image.

### Additional Details Related to the Disclosed Embodiments

Disclosed embodiments may comprise or utilize a special-purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are one or more “computer-readable recording media”, “physical computer storage media” or “hardware storage device(s).” Computer-readable media that merely carry computer-executable instructions without storing the computer-executable instructions are “transmission media.” Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in hardware in the form of computer-executable instructions, data, or data structures and that can be accessed by a general-purpose or special-purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium.

Transmission media can include a network and/or data links that can be used to carry program code in the form of computer-executable instructions or data structures, and which can be accessed by a general-purpose or special-purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Disclosed embodiments may comprise or utilize cloud computing. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“laaS”), and deployment models (e.g., private cloud, community cloud, public cloud, hybrid cloud, etc.).

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAS, pagers, routers, switches, wearable devices, and the like. The invention may also be practiced in distributed system environments where multiple computer systems (e.g., local and remote systems), which are linked through a network (either by hardwired data links, wireless data links, or by a combination of hardwired and wireless data links), perform tasks. In a distributed system environment, program modules may be located in local and/or remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Application-specific Standard Products (ASSPs), System-on-a-chip systems (SOCs), Complex Programmable Logic Devices (CPLDs), central processing units (CPUs), graphics processing units (GPUs), and/or others.

As used herein, the terms “executable module,” “executable component,” “component,” “module,” or “engine” can refer to hardware processing units or to software objects, routines, or methods that may be executed on one or more computer systems. The different components, modules, engines, and services described herein may be implemented as objects or processors that execute on one or more computer systems (e.g., as separate threads).

One will also appreciate how any feature or operation disclosed herein may be combined with any one or combination of the other features and operations disclosed herein. Additionally, the content or feature in any one of the figures may be combined or used in connection with any content or feature used in any of the other figures. In this regard, the content disclosed in any one figure is not mutually exclusive and instead may be combinable with the content from any of the other figures.

As used herein, the term “about”, when used to modify a numerical value or range, refers to any value within 5%, 10%, 15%, 20%, or 25% of the numerical value modified by the term “about”.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A system for performing asymmetric multi-modal image fusion, the system comprising:
one or more processors; and
one or more computer-readable recording media that store instructions that are executable by the one or more processors to configure the system to:
access a first image associated with a first imaging modality;
decompose the first image into a first base layer and a first detail layer;
determine a weight map based on pixel signals of the first image; and
generate an output image by performing image fusion using the first base layer, the first detail layer, and a second detail layer associated with a second imaging modality that is different from the first imaging modality, wherein the weight map modifies the first detail layer and the second detail layer in the image fusion.

2. The system of claim 1, wherein the first imaging modality comprises a visible light imaging modality.

3. The system of claim 1, wherein the second imaging modality comprises a thermal imaging modality.

4. The system of claim 1, wherein the first base layer comprises a first low-frequency component of the first image, and wherein the first detail layer comprises a first high-frequency component of the first image.

5. The system of claim 4, wherein the first low-frequency component is determined by:
generating a downscaled first image by downscaling the first image;
generating a filtered downscaled first image by applying a blurring or smoothing filter to the downscaled first image; and
generating the first low-frequency component by upscaling the filtered downscaled first image.

6. The system of claim 4, wherein the first high-frequency component is determined by subtracting the first low-frequency component from the first image.

7. The system of claim 4, wherein the second detail layer comprises a second high-frequency component of a second image associated with the second imaging modality.

8. The system of claim 7, wherein the second detail layer is obtained by:
generating a downscaled second image by downscaling the second image;
generating a filtered downscaled second image by applying a blurring or smoothing filter to the downscaled second image;
generating a second low-frequency component by upscaling the filtered downscaled second image; and
subtracting the second low-frequency component from the second image.

9. The system of claim 8, wherein the image fusion refrains from using the second low-frequency component.

10. The system of claim 7, wherein the first image and the second image comprise geometry-corrected images.

11. The system of claim 1, wherein the weight map comprises an alpha map.

12. The system of claim 11, wherein values of the alpha map are determined by evaluating a negative exponential function at each of the pixel signals of the first image.

13. The system of claim 1, wherein the image fusion further uses a pedestal component to shift pixel values into a positive domain.

14. The system of claim 13, wherein the pedestal component is based on differences between a maximum pedestal value and pixel values of the first base layer.

15. The system of claim 13, wherein the pedestal component is modified by the weight map.

16. A system for performing asymmetric multi-modal image fusion, the system comprising:
one or more processors; and
one or more computer-readable recording media that store instructions that are executable by the one or more processors to configure the system to:
access a first image associated with a first imaging modality;
decompose the first image into a first low-frequency component and a first high-frequency component;
access a second image associated with a second imaging modality that is different from the first imaging modality;
decompose the second image into a second low-frequency component and a second high-frequency component;
generate a fused detail layer by fusing the first high-frequency component with the second high-frequency component using a weight map based on pixel signals of the first image; and
generate an output image by combining the fused detail layer with the first low-frequency component.

17. The system of claim 16, wherein generating the output image refrains from using the second low-frequency component.

18. The system of claim 16, wherein values of the weight map are determined by evaluating a negative exponential function at each of the pixel signals of the first image.

19. The system of claim 16, wherein the output image is generated by applying a pedestal component to shift pixel values into a positive domain.

20. A system for performing asymmetric multi-modal image fusion, the system comprising:
one or more processors; and
one or more computer-readable recording media that store instructions that are executable by the one or more processors to configure the system to:
access a first image associated with a first imaging modality;
determine a per-pixel signal quality measurement of the first image; and
generate an output image at least by combining a component of the first image with a component of a second image associated with a second imaging modality that is different from the first imaging modality, wherein a per-pixel contribution of the component of the second image is negatively related to the per-pixel signal quality measurement of the first image.
